(19) United States
(12) Patent Application Publication
(10) Pub. No.: US 2020/0210836 A1
(43) Pub. Date: Jul. 2, 2020

(54) NEURAL NETWORK OPTIMIZING DEVICE AND NEURAL NETWORK OPTIMIZING METHOD

(71) Applicant: SAMSUNG ELECTRONICS CO., LTD., SUWONSI-SI (KR)

(72) Inventors: KYOUNG YOUNG KIM, SUWON-SI (KR); SANG SOO KO, YONGIN-SI (KR); BYEOUNG-SU KIM, HWASEONG-SI (KR); JAE GON KIM, HWASEONG-SI (KR); DO YUN KIM, GWACHEON-SI (KR); SANG HYUCK HA, YONGIN-SI (KR)

(21) Appl. No.: 16/550,190

(22) Filed: Aug. 24, 2019

(30) Foreign Application Priority Data
Jan. 2, 2019 (KR) 10-2019-0000078

(51) Int. Cl. G06N 3/08; G06F 11/34

(52) U.S. Cl. CPC G06N 3/082; G06F 11/3466

(57) ABSTRACT

A neural network optimizing device includes a performance estimating module that outputs estimated performance according to performing operations of a neural network based on limitation requirements on resources used to perform the operations of the neural network. A portion selecting module receives the estimated performance from the performance estimating module and selects a portion of the neural network which deviates from the limitation requirements. A new neural network generating module generates, through reinforcement learning, a subset by changing a layer structure included in the selected portion of the neural network, determines an optimal layer structure based on the estimated performance provided from the performance estimating module, and changes the selected portion to the optimal layer structure to generate a new neural network. A final neural network output module outputs the new neural network generated by the new neural network generating module as a final neural network.

### CROSS-REFERENCE TO RELATED APPLICATION

This application claims priority from Korean Patent Application No. 10-2019-0000078 filed on Jan. 2, 2019 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a neural network optimizing device and a neural network optimizing method.

### 2. Description of the Related Art

Deep learning refers to an operational architecture based on a set of algorithms using a deep graph with multiple processing layers to model a high level of abstraction in the input data. Generally, a deep learning architecture may include multiple neuron layers and parameters. For example, as one of deep learning architectures, Convolutional Neural Network (CNN) is widely used in many artificial intelligence and machine learning applications such as image classification, image caption generation, visual question answering and auto-driving vehicles.

The neural network system, for example, includes a large number of parameters for image classification and requires a large number of operations. Accordingly, it has high complexity and consumes a large amount of resources and power. Thus, in order to implement a neural network system, a method for efficiently calculating these operations is required. In particular, in a mobile environment in which resources are provided in a limited manner, for example, it is more important to increase the computational efficiency.

### SUMMARY

Aspects of the present disclosure provide a neural network optimizing device and method to increase the computational efficiency of the neural network.

Aspects of the present disclosure also provide a device and method for optimizing a neural network in consideration of resource limitation requirements and estimated performance in order to increase the computational efficiency of the neural network particularly in a resource-limited environment.

According to an aspect of the present disclosure, there is provided a neural network optimizing device including: a performance estimating module configured to output estimated performance according to performing operations of a neural network based on limitation requirements on resources used to perform the operations of the neural network; a portion selecting module configured to receive the estimated performance from the performance estimating module and select a portion of the neural network which deviates from the limitation requirements; a new neural network generating module configured to, through reinforcement learning, generate a subset by changing a layer structure included in the selected portion of the neural network, determine an optimal layer structure based on the estimated performance provided from the performance estimating module, and change the selected portion to the optimal layer structure to generate a new neural network; and a final neural network output module configured to output the new neural network generated by the new neural network generating module as a final neural network.

According to another aspect of the present disclosure, there is provided a neural network optimizing device including: a performance estimating module configured to output estimated performance according to performing operations of a neural network based on limitation requirements on resources used to perform the operations of the neural network; a portion selecting module configured to receive the estimated performance from the performance estimating module and select a portion of the neural network which deviates from the limitation requirements; a new neural network generating module configured to generate a subset by changing a layer structure included in the selected portion of the neural network, and generate a new neural network by changing the selected portion to an optimal layer structure based on the subset; a neural network sampling module configured to sample the subset from the new neural network generating module; a performance check module configured to check the performance of the neural network sampled in the subset provided by the neural network sampling module and provide update information to the performance estimating module based on the check result; and a final neural network output module configured to output the new neural network generated by the new neural network generating module as a final neural network.

According to another aspect of the present disclosure, there is provided a neural network optimizing method including: estimating performance according to performing operations of a neural network based on limitation requirements on resources used to perform the operations of the neural network; selecting a portion of the neural network which deviates from the limitation requirements based on the estimated performance; through reinforcement learning, generating a subset by changing a layer structure included in the selected portion of the neural network, and determining an optimal layer structure based on the estimated performance; changing the selected portion to the optimal layer structure to generate a new neural network; and outputting the generated new neural network as a final neural network.

According to another aspect of the present disclosure, there is provided a non-transitory, computer-readable storage medium storing instructions that when executed by a computer cause the computer to execute a method. The method includes: (1) determining a measure of expected performance of an operation by an idealized neural network; (2) identifying, from the measure, a deficient portion of the idealized neural network that does not comport with a resource constraint; (3) generating an improved portion of the idealized neural network based on the measure and the resource constraint; (4) substituting the improved portion for the deficient portion in the idealized neural network to produce a realized neural network; and (5) executing the operation with the realized neural network.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail example embodiments thereof with reference to the attached drawings, in which:

FIG. 1 is a block diagram illustrating a neural network optimizing device according to an embodiment of the present disclosure;

FIG. 2 is a block diagram illustrating an embodiment of the neural network optimizing module of FIG. 1;

FIG. 3 is a block diagram illustrating the portion selecting module of FIG. 2;

FIG. 4 is a block diagram illustrating the new neural network generating module of FIG. 2;

FIG. 5 is a block diagram illustrating the final neural network output module of FIG. 2;

FIGS. 6 and 7 are diagrams illustrating an operation example of the neural network optimizing device according to an embodiment of the present disclosure;

FIG. 8 is a flowchart illustrating a neural network optimizing method according to an embodiment of the present disclosure;

FIG. 9 is a block diagram illustrating another embodiment of the neural network optimizing module of FIG. 1;

FIG. 10 is a block diagram illustrating another embodiment of the new neural network generating module of FIG. 2; and

FIG. 11 is a flowchart illustrating a neural network optimizing method according to another embodiment of the present disclosure.

### DETAILED DESCRIPTION OF THE EMBODIMENTS

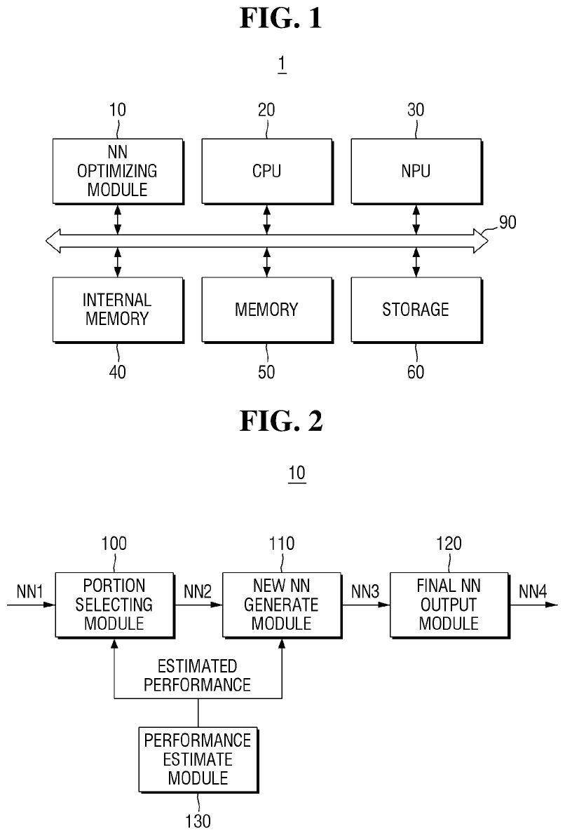

FIG. 1 is a block diagram illustrating a neural network optimizing device according to an embodiment of the present disclosure.

Referring to FIG. 1, a neural network optimizing device 1 according to an example embodiment of the present disclosure may include a neural network (NN) optimizing module 10, a central processing unit (CPU) 20, a neural processing unit (NPU) 30, an internal memory 40, a memory 50 and a storage 60. The neural network optimizing module 10, the central processing unit (CPU) 20, the neural processing unit (NPU) 30, the internal memory 40, the memory 50 and the storage 60 may be electrically connected to each other via a bus 90. However, the configuration illustrated in FIG. 1 is merely an example. Depending on the purpose of implementation, other elements other than the neural network optimizing module 10 may be omitted, and other elements (not shown in FIG. 1, for example, a graphic processing unit (GPU), a display device, an input/output device, a communication device, various sensors, etc.) may be added.

In the present embodiment, the CPU 20 may execute various programs or applications for driving the neural network optimizing device 1 and may control the neural network optimizing device 1 as a whole. The NPU 30 may particularly process a program or an application including a neural network operation alone or in cooperation with the CPU 20.

The internal memory 40 corresponds to a memory mounted inside the neural network optimizing device 1 when the neural network optimizing device 1 is implemented as a System on Chip (SoC), such as an Application Processor (AP). The internal memory 40 may include, for example, a static random-access memory (SRAM), but the scope of the present disclosure is not limited thereto.

On the other hand, the memory 50 corresponds to a memory implemented externally when the neural network optimizing device 1 is implemented as an SoC, such as an AP. The external memory 50 may include a dynamic random-access memory (DRAM), but the scope of the present disclosure is not limited thereto.

Meanwhile, the neural network optimizing device 1 according to an embodiment of the present disclosure may be implemented as a mobile device having limited resources, but the scope of the present disclosure is not limited thereto.

A neural network optimizing method according to various embodiments described herein may be performed by the neural network optimizing module 10. The neural network optimizing module 10 may be implemented in hardware, in software, or in hardware and software. Further, it is needless to say that the neural network optimizing method according to various embodiments described herein may be implemented in software and executed by the CPU 20 or may be executed by the NPU 30. For simplicity of description, a neural network optimization method according to various embodiments will be mainly described with reference to the neural network optimization module 10. When implemented in software, the software may be stored in a computer-readable non-volatile storage medium.

The neural network optimizing module 10 optimizes the neural network to increase the computational efficiency of the neural network. Specifically, the neural network optimizing module 10 performs a task of changing a portion of the neural network into an optimized structure by using the limitation requirements on the resources used to perform operations of the neural network and the estimated performance according to performing operations of the neural network.

The term “performance” as used herein may be used to describe aspects such as processing time, power consumption, computation amount, memory bandwidth usage, and memory usage according to performing operations of the neural network when an application is executed or implemented in hardware, such as a mobile device. The term “estimated performance” may refer to estimated values for these aspects, that is, for example, estimated values for processing time, power consumption, computation amount, memory bandwidth usage and memory usage according to performing operations of the neural network. For example, when a certain neural network application is executed in a specific mobile device, the memory bandwidth usage according to performing operations of the neural network may be estimated to be 1.2 MB. As another example, when a neural network application is executed in a specific mobile device, the consumed power according to performing operations of the neural network may be estimated to be 2 W.

Here, the estimated performance may include a value that can be estimated in hardware and a value that can be estimated in software. For example, the above-mentioned processing time may include estimated values in consideration of the computation time, latency and the like of the software, which can be detected in software, as well as the driving time of the hardware, which can be detected in hardware. Further, the estimated performance is not limited to the processing time, power consumption, computation amount, memory bandwidth usage and memory usage according to performing operations of the neural network, but may include estimated values for any indicator that is considered necessary to estimate the performance in terms of hardware or software.

Here, the term “limitation requirements” may be used to describe resources, i.e., limited resources which can be used to perform operations of a neural network in a mobile device. For example, the maximum bandwidth for accessing an internal memory that is allowed to perform operations of a neural network in a particular mobile device may be limited to 1 MB. As another example, the maximum power consumption allowed to perform an operation of a neural network in a particular mobile device may be limited to 10 W.

Therefore, in a case where the limitation requirement for the maximum bandwidth of the internal memory used for the operation of a neural network is 1 MB, if the estimated performance according to performing operations of the neural network is determined to be 1.2 MB, it may exceed the resources provided by the mobile device. In this case, depending on the implementation, a neural network may be computed using a memory with a larger allowed memory bandwidth and a higher access cost instead of an internal memory, which may reduce the computational efficiency and cause unintentional computation delays.

Hereinafter, a device and method for optimizing a neural network in consideration of resource limitation requirements and estimated performance in order to increase the computational efficiency of a neural network in a resource-limited environment will be described in detail.

FIG. 2 is a block diagram illustrating an embodiment of the neural network optimizing module of FIG. 1.

Referring to FIG. 2, the neural network optimizing module 10 of FIG. 1 includes a portion selecting module 100, a new neural network generating module 110, a final neural network output module 120 and a performance estimating module 130.

First, the performance estimating module 130 outputs estimated performance according to performing operations of the neural network based on limitation requirements on resources used to perform computation of the neural network. For example, based on the limitation requirement of 1 MB for the maximum memory bandwidth of the internal memory for performing operations of the neural network, the estimated performance is outputted such that the performance according to performing operations of the neural network is estimated to be 1.2 MB or 0.8 MB. In this case, when the estimated performance is 0.8 MB, it is not necessary to optimize the neural network because it does not deviate from the limitation requirements. However, when the estimated performance is 1.2 MB, it may be determined that optimization of the neural network is necessary.

The portion selecting module 100 receives the estimated performance from the performance estimating module 130 and selects a portion of the neural network that deviates from the limitation requirements. Specifically, the portion selecting module 100 receives an input of a neural network NN1, selects a portion of the neural network NN1 that deviates from the limitation requirements, and outputs the selected portion as a neural network NN2.

The new neural network generating module 110 generates a subset by changing the layer structure included in the selected portion of the neural network NN2 and generates a new neural network NN3 by changing the selected portion to an optimal layer structure based on the subset. Here, the selected portion of the neural network NN2 may include, for example, relu, relu6, sigmoid, tan h and the like, which are used as a convolution layer, a pooling layer, a fully connected layer (FC layer), a deconvolution layer and an activation function, which are mainly used in a Convolutional Neural Network (CNN) series. In addition, the selected portion may include lstm cell, rnn cell, gru cell, etc., which are mainly used in a Recurrent Neural Network (RNN) series. Further, the selected portion may include not only a cascade connection structure of the layers but also other identity paths or skip connection and the like.

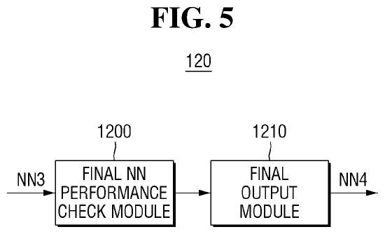

The subset refers to a set of layer structures and other layer structures included in the selected portion of the neural network NN2. That is, the subset refers to a change layer structure obtained by performing various changes to improve the layer structure included in the selected portion of the neural network NN2. The change layer structure included in the subset may be one or two or more. The new neural network generating module 110 may, through reinforcement learning, generate one or more change layer structures in which a layer structure included in the selected portion is changed, which will be described later in detail with reference to FIG. 4, and determine an optimal layer structure that is evaluated as being optimized for the mobile device environment.

The final neural network output module 120 outputs the new neural network NN3 generated by the new neural network generating module 110 as a final neural network NN4. The final neural network NN4 outputted from the final neural network output module 120 may be transmitted to, for example, the NPU 30 of FIG. 1 and processed by the NPU 30.

In some embodiments of the present disclosure, the performance estimating module 130 may use the following performance estimation table.

TABLE 1

| | Conv | Pool | FC |
|---|---|---|---|
| Processing Time | PT_{conv} | PTₚₒₒₗ | PT_{FC} |
| Power | P_{conv} | Pₚₒₒₗ | P_{FC} |
| Data Transmission Size | D_{conv} | Dₚₒₒₗ | D_{FC} |

| | |
|---|---|
| Internal Memory | 1 MB |

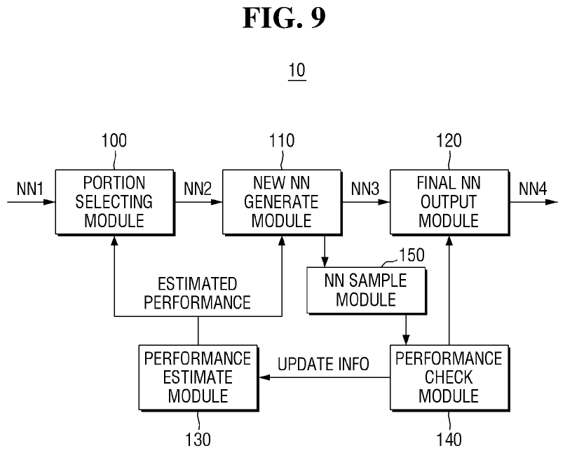

That is, the performance estimating module 130 may store and use estimated performance values by reflecting the limitation requirements of the mobile device in a data structure as shown in Table 1. The values stored in Table 1 may be updated according to the update information provided from a performance check module 140 to be described later with reference to FIG. 9.

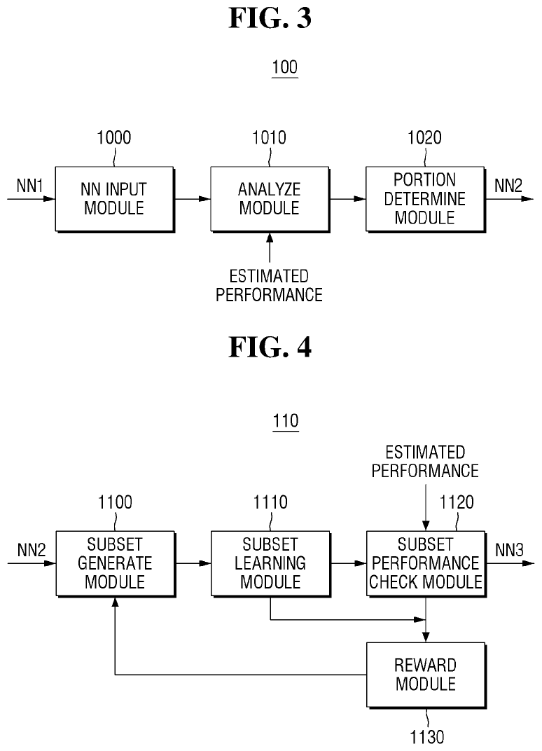

FIG. 3 is a block diagram illustrating the portion selecting module of FIG. 2.

Referring to FIG. 3, the portion selecting module 100 of FIG. 2 may include a neural network input module 1000, an analyzing module 1010 and a portion determining module 1020.

The neural network input module 1000 receives an input of the neural network NN1. The neural network NN1 may include, for example, a convolution layer, and may include a plurality of convolution operations performed in the convolution layer.

The analyzing module 1010 searches the neural network NN1 to analyze whether the estimated performance provided from the performance estimating module 130 deviates from the limitation requirements. For example, referring to the data as shown in Table 1, the analyzing module 1010 analyzes whether the estimated performance of the convolution operation deviates from the limitation requirements. For example, the analyzing module 1010 may refer to the value PTconv to analyze whether the estimated performance on the processing time of a convolution operation deviates from the limitation requirements. As another example, the analyzing module 1010 may refer to the value Ppool to analyze whether the estimated performance of a pooling operation deviates from the limitation requirements.

The performance estimating module 130 may provide the analyzing module 1010 with only estimated performance for one indicator, that is, a single indicator. For example, the performance estimating module 130 may output only the estimated performance for memory bandwidth usage according to performing operations of the neural network based on the limitation requirements on resources.

Alternatively, the performance estimating module 130 may provide the analyzing module 1010 with the estimated performance for two or more indicators, i.e., a composite indicator. For example, the performance estimating module 130 may output the estimated performance for processing time, power consumption and memory bandwidth usage according to performing operations of the neural network based on the limitation requirements on resources. In this case, the analyzing module 1010 may analyze whether the estimated performance deviates from the limitation requirements in consideration of at least two indicators indicative of the estimated performance while searching the neural network NN1.

The portion determining module 1020 determines, as a portion, a layer in which the estimated performance deviates from the limitation requirements according to the result of the analysis performed by the analyzing module 1010. Then, the portion determining module 1020 transmits the neural network NN2 corresponding to the result to the new neural network generating module 110.

In some embodiments of the present disclosure, the portion determining module 1020 may set a threshold reflecting the limitation requirements and then analyze whether the estimated performance exceeds a threshold. Here, the threshold may be expressed as the value shown in Table 1 above.

FIG. 4 is a block diagram illustrating the new neural network generating module of FIG. 2.

Referring to FIG. 4, the neural network generating module 110 of FIG. 2 may include a subset generating module 1100, a subset learning module 1110, a subset performance check module 1120 and a reward module 1130.

The neural network generating module 110, through reinforcement learning, generates a subset by changing the layer structure included in the selected portion of the neural network NN2 provided from the portion selecting module 100, learns the generated subset, determines the optimal layer structure by receiving the estimated performance from the performance estimating module 130, and changes the selected portion to the optimal layer structure to generate a new neural network NN3.

The subset generating module 1100 generates a subset including at least one change layer structure generated by changing the layer structure of the selected portion. Changing the layer structure includes, for example, when the convolution operation is performed once and the computation amount is A, and when it is determined that the computation amount of A deviates from the limitation requirements, performing the convolution operation twice or more and then summing up the respective values. In this case, each of the convolution operations performed separately may have a computation amount of B that does not deviate from the limitation requirements.

The subset generating module 1100 may generate a plurality of change layer structures. Further, the generated change layer structures may be defined and managed as a subset. Since there are many methods of changing the layer structure, several candidate layer structures are created to find the optimal layer structure later.

The subset learning module 1110 learns the generated subset. The method of learning the generated subset is not limited to a specific method.

The subset performance check module 1120 checks the performance of the subset using the estimated performance provided from the performance estimating module 130 and determines an optimal layer structure to generate a new neural network. That is, the subset performance check module 1120 determines an optimal layer structure suitable for the environment of the mobile device by checking the performance of the subset including multiple change layer structures. For example, when the subset has a first change layer structure and a second change layer structure, by comparing the efficiency of the first change layer structure and the efficiency of the second change layer structure again, a more efficient change layer structure may be determined as an optimal layer structure.

The reward module 1130 provides a reward to the subset generating module 1100 based on the subset learned by the subset learning module 1110 and the performance of the checked subset. Then, the subset generating module 1100 may generate a more efficient change layer structure based on the reward.

That is, the reward refers to a value to be transmitted to the subset generating module 1100 in order to generate a new subset in the reinforcement learning. For example, the reward may include a value for the estimated performance provided from the performance estimating module 130. Here, the value for the estimated performance may include, for example, one or more values for the estimated performance per layer. As another example, the reward may include a value for the estimated performance provided by the performance estimating module 130 and a value for the accuracy of the neural network provided from the subset learning module 1110.

The subset performance check module 1120, through the reinforcement learning as described above, generates a subset, checks the performance of the subset, generates an improved subset from the subset, and then checks the performance of the improved subset. Accordingly, after determining the optimal layer structure, the new neural network NN3 having the selected portion changed to the optimal layer structure is transmitted to the final neural network output module 120.

FIG. 5 is a block diagram illustrating the final neural network output module of FIG. 2.

Referring to FIG. 5, the final neural network output module 120 of FIG. 2 may include a final neural network performance check module 1200 and a final output module 1210.

The final neural network performance check module 1200 further checks the performance of the new neural network NN3 provided from the new neural network generating module 110. In some embodiments of the present disclosure, an additional check may be made by the performance check module 140 to be described below with reference to FIG. 9.

The final output module 1210 outputs a final neural network NN4. The final neural network NN4 outputted from the final output module 1210 may be transmitted to the NPU 30 of FIG. 1, for example, and processed by the NPU 30.

According to the embodiment of the present disclosure described with reference to FIGS. 2 to 5, the new neural network generating module 110 generates and improves a subset including a change layer structure through reinforcement learning, provides various change layer structures as candidates and selects an optimal layer structure among them. Thus, the neural network optimization can be achieved to increase the computational efficiency of the neural network particularly in a resource-limited environment.

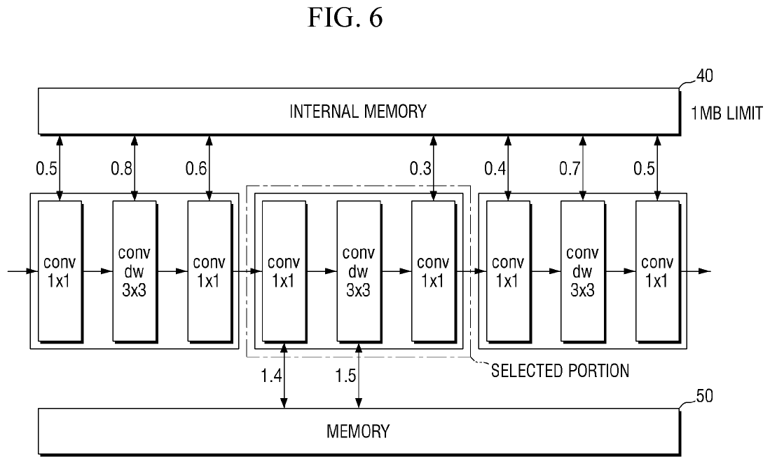

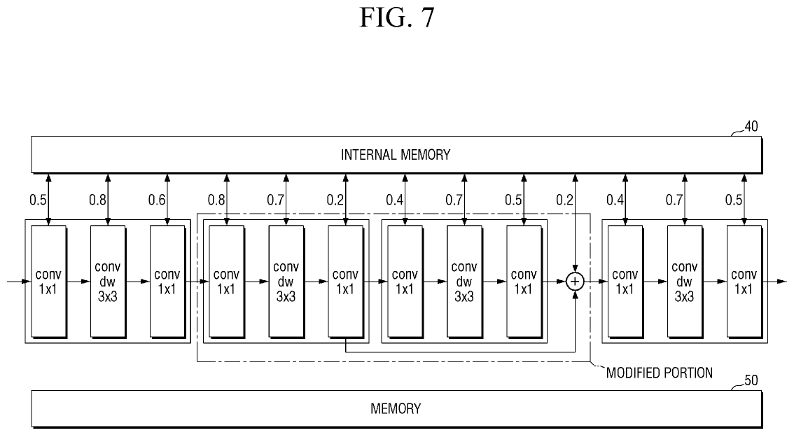

FIGS. 6 and 7 are diagrams illustrating an operation example of the neural network optimizing device according to an embodiment of the present disclosure.

Referring to FIG. 6, the neural network includes a plurality of convolution operations. Here, the internal memory 40 provides a bandwidth of up to 1 MB with low access cost, while the memory 50 provides a larger bandwidth with high access cost.

Among the plurality of convolution operations, the first to third operations and the sixth to ninth operations have the estimated performance of 0.5 MB, 0.8 MB, 0.6 MB, 0.3 MB, 0.4 MB, 0.7 MB and 0.5 MB, respectively, which do not deviate from the limitation requirements of the memory bandwidth. However, the fourth operation and the fifth operation have the estimated performance of 1.4 MB and 1.5 MB, respectively, which deviate from the limitation requirements of the memory bandwidth.

In this case, the portion selecting module 100 may select a region including the fourth operation and the fifth operation. Then, as described above, the new neural network generating module 110 generates and improves a subset including a change layer structure through reinforcement learning, provides various change layer structures as candidates, selects an optimal layer structure from among them, and changes the selected portion to the optimal layer structure.

Referring to FIG. 7, the selected portion in FIG. 6 has been changed to a modified portion that includes seven operations from the conventional three operations.

Specifically, the seven operations include six convolution operations which are changed to have the estimated performance of 0.8 MB, 0.7 MB, 0.2 MB, 0.4 MB, 0.7 MB and 0.5 MB, respectively, which do not deviate from the limitation requirements of the memory bandwidth, and a sum operation having the estimated performance of 0.2 MB, which also does not deviate from the limitation requirements of the memory bandwidth.

As described above, the new neural network generating module 110 generates and improves a subset including a change layer structure through reinforcement learning, provides various change layer structures as candidates, and selects an optimal layer structure from among them. Thus, the neural network optimization can be achieved to increase the computational efficiency of the neural network particularly in a resource-limited environment.

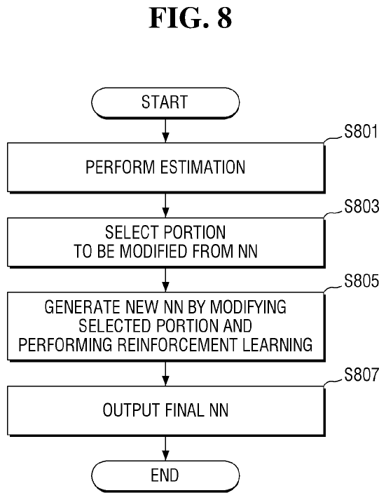

FIG. 8 is a flowchart illustrating a neural network optimizing method according to an embodiment of the present disclosure.

Referring to FIG. 8, a neural network optimizing method according to an embodiment of the present disclosure includes estimating the performance according to performing operations of the neural network, based on the limitation requirements on resources used to perform operations of the neural network (S801).

The method further includes selecting, based on the estimated performance, a portion that deviates from the limitation requirements and needs to be changed in the neural network (S803).

The method further includes, through reinforcement learning, generating a subset by changing a layer structure included in the selected portion of the neural network, determining an optimal layer structure based on the estimated performance, and changing the selected portion to an optimal layer structure to generate a new neural network (S805).

The method further includes outputting the generated new neural network as a final neural network (S807).

In some embodiments of the present disclosure, selecting a portion that deviates from the limitation requirements may include receiving an input of the neural network, searching the neural network, analyzing whether the estimated performance deviates from the limitation requirements, and determining a layer in which the estimated performance deviates from the limitation requirements as the portion.

In some embodiments of the present disclosure, analyzing whether the estimated performance deviates from the limitation requirements may include setting a threshold that reflects the limitation requirements, and then, analyzing whether the estimated performance exceeds the threshold.

In some embodiments of the present disclosure, the subset includes one or more change layer structures generated by changing the layer structure of the selected portion and determining the optimal layer structure includes learning the generated subset, checking the performance of the subset using the estimated performance, and providing a reward based on the learned subset and the performance of the checked subset.

In some embodiments of the present disclosure, outputting the new neural network as a final neural network further includes checking the performance of the final neural network.

FIG. 9 is a block diagram illustrating another embodiment of the neural network optimizing module of FIG. 1.

Referring to FIG. 9, the neural network optimizing module 10 of FIG. 1 further includes a performance check module 140 and a neural network sampling module 150 in addition to a portion selecting module 100, a new neural network generating module 110, a final neural network output module 120 and a performance estimating module 130.

The performance estimating module 130 outputs estimated performance according to performing operations of the neural network, based on the limitation requirements on resources used to perform operations of the neural network.

The portion selecting module 100 receives the estimated performance from the performance estimating module 130 and selects a portion of the neural network NN1 that deviates from the limitation requirements.

The new neural network generating module 110 generates a subset by changing the layer structure included in the selected portion of the neural network NN2 and changes the selected portion to the optimal layer structure based on the subset to generate a new neural network NN3.

The final neural network output module 120 outputs the new neural network NN3 generated by the new neural network generating module 110 as a final neural network NN4.

The neural network sampling module 150 samples a subset from the new neural network generating module 110.

The performance check module 140 checks the performance of the neural network sampled in the subset provided by the neural network sampling module 150 and provides update information to the performance estimating module 130 based on the check result.

That is, although the performance estimating module 130 may be already used for checking the performance, the present embodiment further includes the performance check module 140 which can perform a more precise performance check than the performance estimating module 130 to optimize the neural network to match up to the performance of hardware such as mobile devices. Further, the check result of the performance check module 140 may be provided as update information to the performance estimating module 130 to improve the performance of the performance estimating module 130.

Meanwhile, the performance check module 140 may include a hardware monitoring module. The hardware monitoring module may monitor and collect information about hardware such as computation time, power consumption, peak-to-peak voltage, temperature and the like. Then, the performance check module 140 may provide the information collected by the hardware monitoring module to the performance estimating module 130 as update information, thereby further improving the performance of the performance estimating module 130. For example, the updated performance estimating module 130 may grasp more detailed characteristics such as latency for each layer and computation time for each of the monitored blocks.

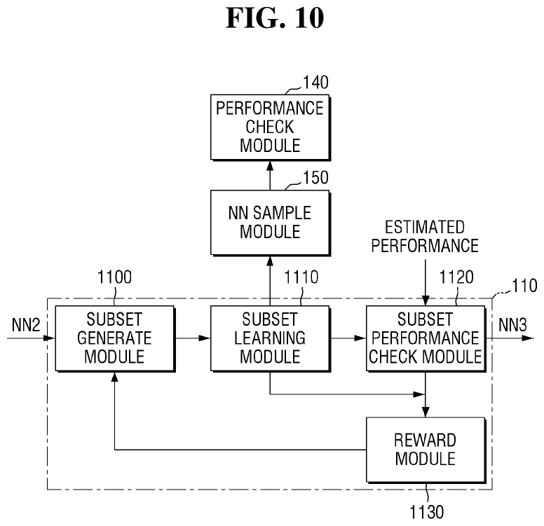

FIG. 10 is a block diagram illustrating another embodiment of the new neural network generating module of FIG. 2.

Referring to FIG. 10, specifically, the neural network sampling module 150 may receive and sample a subset from the subset learning module 1110 of the new neural network generating module 110. As described above, by sampling various candidate solutions and precisely analyzing the performance, it is possible to further improve the neural network optimization quality for increasing the computational efficiency of the neural network.

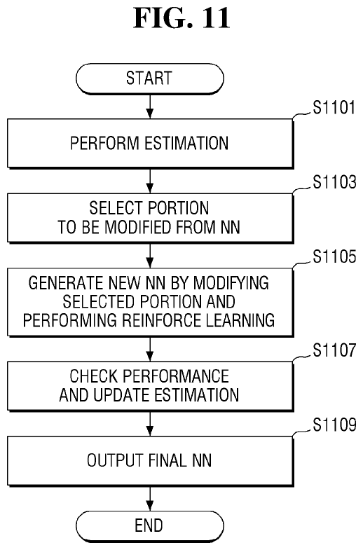

FIG. 11 is a flowchart illustrating a neural network optimizing method according to another embodiment of the present disclosure.

Referring to FIG. 11, a neural network optimizing method according to another embodiment of the present disclosure includes estimating the performance according to performing operations of the neural network based on the limitation requirements on resources used to perform operations of the neural network (S1101).

The method further includes selecting, based on the estimated performance, a portion that deviates from the limitation requirements and needs to be changed in the neural network (S1103).

The method further includes, through reinforcement learning, generating a subset by changing a layer structure included in the selected portion of the neural network through determining an optimal layer structure based on the estimated performance and changing the selected portion to an optimal layer structure to generate a new neural network (S1105).

The method further includes sampling a subset, checking the performance of the neural network sampled in the subset, performing an update based on the check result and recalculating the estimated performance (S1107).

The method further includes outputting the generated new neural network as a final neural network (S1109).

In some embodiments of the present disclosure, selecting a portion that deviates from the limitation requirements may include receiving an input of the neural network, searching the neural network, analyzing whether the estimated performance deviates from the limitation requirements and determining a layer in which the estimated performance deviates from the limitation requirements as the portion.

In some embodiments of the present disclosure, analyzing whether the estimated performance deviates from the limitation requirements may include setting a threshold that reflects the limitation requirements and then analyzing whether the estimated performance exceeds the threshold.

In some embodiments of the present disclosure, the subset includes one or more change layer structures generated by changing the layer structure of the selected portion and determining the optimal layer structure includes learning the generated subset, checking the performance of the subset using the estimated performance, and providing a reward based on the learned subset and the performance of the checked subset.

In some embodiments of the present disclosure, outputting the new neural network as a final neural network further includes checking the performance of the final neural network.

Meanwhile, in another embodiment of the present disclosure, the limitation requirements may include a first limitation requirement and a second limitation requirement different from the first limitation requirement and the estimated performance may include first estimated performance according to the first limitation requirement and second estimated performance according to the second limitation requirement.

In this case, the portion selecting module 100 selects a first portion in which the first estimated performance deviates from the first limitation requirement in the neural network and a second portion in which the second estimated performance deviates from the second limitation requirement. The new neural network generating module 110 may change the first portion to the first optimal layer structure and change the second portion to the second optimal layer structure to generate a new neural network. Here, the first optimal layer structure is a layer structure determined through reinforcement learning from the layer structure included in the first portion and the second optimal layer structure is a layer structure determined through reinforcement learning from the layer structure included in the second portion.

According to various embodiments of the present disclosure as described above, the new neural network generating module 110 generates and improves a subset including a change layer structure through reinforcement learning, provides various change layer structures as candidates and selects an optimal layer structure among them. Thus, the neural network optimization can be achieved to increase the computational efficiency of the neural network particularly in a resource-limited environment.

The present disclosure further includes the performance check module 140 which can perform a more precise performance check than the performance estimating module 130 to optimize the neural network to match up to the performance of hardware, such as mobile devices. Further, the check result of the performance check module 140 may be provided as update information to the performance estimating module 130 to improve the performance of the performance estimating module 130.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In concluding the detailed description, those skilled in the art will appreciate that many variations and modifications may be made to the preferred embodiments without substantially departing from the principles of the present disclosure. Therefore, the disclosed preferred embodiments of the disclosure are used in a generic and descriptive sense only and not for purposes of limitation.

1. A neural network optimizing device comprising:
a performance estimating module configured to output estimated performance based on operations of a neural network and limitation requirements of resources used to perform the operations of the neural network;
a portion selecting module configured to receive the estimated performance from the performance estimating module and select a portion of the neural network whose operation deviates from the limitation requirements;
a new neural network generating module configured to, through reinforcement learning, generate a subset by changing a layer structure included in the portion of the neural network, determine an optimal layer structure based on the estimated performance, and change the portion to the optimal layer structure to generate a new neural network; and
a final neural network output module configured to output the new neural network generated by the new neural network generating module as a final neural network.

2. The neural network optimizing device of claim 1, wherein the portion selecting module includes:
a neural network input module configured to receive information of the neural network;
an analyzing module configured to search the information of the neural network and analyze whether the estimated performance deviates from the limitation requirements; and
a portion determining module configured to determine a layer in which the estimated performance deviates from the limitation requirements as the portion.

3. The neural network optimizing device of claim 2, wherein the analyzing module sets a threshold reflecting the limitation requirements and then analyzes whether the estimated performance exceeds the threshold.

4. The neural network optimizing device of claim 1, wherein the new neural network generating module includes:
a subset generating module configured to generate the subset including at least one change layer structure generated by changing the layer structure of the portion;
a subset learning module configured to learn the subset generated by the subset generating module;
a subset performance check module configured to check the performance of the subset using the estimated performance and determine the optimal layer structure to generate the new neural network; and
a reward module configured to provide a reward to the subset generating module based on the subset learned by the subset learning module and the performance of the subset checked by the subset performance check module.

5. The neural network optimizing device of claim 1, wherein the final neural network output module includes:
a final neural network performance check module configured to check the performance of the final neural network; and
a final output module configured to output the final neural network.

6. The neural network optimizing device of claim 1, further comprising:
a neural network sampling module configured to sample the subset generated by the new neural network generating module; and
a performance check module configured to check the performance of the neural network sampled in the subset and provide update information to the performance estimating module based on a result of the check executed by the performance check module.

7. The neural network optimizing device of claim 1, wherein the performance estimating module outputs the estimated performance for a single indicator.

8. The neural network optimizing device of claim 1, wherein the performance estimating module outputs the estimated performance for a composite indicator.

9. The neural network optimizing device of claim 1, wherein:
the limitation requirements include a first limitation requirement and a second limitation requirement different from the first limitation requirement, and the estimated performance includes first estimated performance according to the first limitation requirement and second estimated performance according to the second limitation requirement,
the portion selecting module selects a first portion in which the first estimated performance deviates from the first limitation requirement in the neural network and a second portion in which the second estimated performance deviates from the second limitation requirement, and
the new neural network generating module changes the first portion to a first optimal layer structure and changes the second portion to a second optimal layer structure to generate the new neural network, the first optimal layer structure is a layer structure determined through the reinforcement learning from the layer structure included in the first portion, and the second optimal layer structure is a layer structure determined through the reinforcement learning from the layer structure included in the second portion.

10. A neural network optimizing device comprising:
a performance estimating module configured to output estimated performance based on operations of a neural network and limitation requirements of resources used to perform the operations of the neural network;
a portion selecting module configured to receive the estimated performance from the performance estimating module and select a portion of the neural network which deviates from the limitation requirements;
a new neural network generating module configured to generate a subset by changing a layer structure included in the portion of the neural network and generate a new neural network by changing the portion to an optimal layer structure based on the subset;
a neural network sampling module configured to sample the subset from the new neural network generating module;
a performance check module configured to check the performance of the neural network sampled in the subset and provide update information to the performance estimating module based on a result of the check executed by the performance check module; and
a final neural network output module configured to output the new neural network generated by the new neural network generating module as a final neural network.

11. The neural network optimizing device of claim 10, wherein the portion selecting module includes:
a neural network input module configured to receive information of the neural network;
an analyzing module configured to search the information of the neural network and analyze whether the estimated performance generated by the performance estimating module deviates from the limitation requirements; and
a portion determining module configured to determine a layer in which the estimated performance deviates from the limitation requirements as the portion.

12. The neural network optimizing device of claim 11, wherein the analyzing module sets a threshold reflecting the limitation requirements and analyzes whether the estimated performance exceeds the threshold.

13. The neural network optimizing device of claim 10, wherein the new neural network generating module includes:
a subset generating module configured to generate the subset including at least one change layer structure generated by changing the layer structure of the portion; and
a subset performance check module configured to check the performance of the subset using the estimated performance and determine the optimal layer structure to generate the new neural network.

14. The neural network optimizing device of claim 13, wherein:
the new neural network generating module performs reinforcement learning to generate the subset and determine the optimal layer structure, and
the neural network optimizing device further comprises:
a subset learning module configured to learn the subset generated by the new neural network generating module; and
a reward module configured to provide a reward to the subset generating module based on the subset learned by the subset learning module and the performance of the subset checked by the subset performance check module.

15. The neural network optimizing device of claim 10, wherein the final neural network output module includes:
a final neural network performance check module configured to check the performance of the final neural network; and
a final output module configured to output the final neural network.

16. The neural network optimizing device of claim 10, wherein the performance estimating module outputs the estimated performance for a single indicator.

17. The neural network optimizing device of claim 10, wherein the performance estimating module outputs the estimated performance for a composite indicator.

18. The neural network optimizing device of claim 10, wherein:
the limitation requirements include a first limitation requirement and a second limitation requirement different from the first limitation requirement, and the estimated performance includes first estimated performance according to the first limitation requirement and second estimated performance according to the second limitation requirement,
the portion selecting module selects a first portion in which the first estimated performance deviates from the first limitation requirement in the neural network and a second portion in which the second estimated performance deviates from the second limitation requirement, and
the new neural network generating module changes the first portion to a first optimal layer structure and changes the second portion to a second optimal layer structure to generate the new neural network, the first optimal layer structure is a layer structure determined through reinforcement learning from the layer structure included in the first portion, and the second optimal layer structure is a layer structure determined through reinforcement learning from the layer structure included in the second portion.

19. A neural network optimizing method comprising:
estimating estimated performance based on performing operations of a neural network and limitation requirements of resources used to perform the operations of the neural network;
selecting a portion of the neural network which deviates from the limitation requirements based on the estimated performance;
through reinforcement learning, generating a subset by changing a layer structure included in the portion of the neural network and determining an optimal layer structure based on the estimated performance;
changing the portion to the optimal layer structure to generate a new neural network; and
outputting the new neural network as a final neural network.

20. The neural network optimizing method of claim 19, wherein selecting a portion of the neural network which deviates from the limitation requirements comprises:
receiving information of the neural network;
searching the information of the neural network and analyzing whether the estimated performance deviates from the limitation requirements; and
determining a layer in which the estimated performance deviates from the limitation requirements as the portion.

21-30. (canceled)
